(19) United States
(12) Patent Application Publication
(10) Pub. No.: US 2014/0322665 A1
(43) Pub. Date: Oct. 30, 2014

(54) GUIDING TEMPLATE FOR DENTAL IMPLANTOLOGY

(71) Applicants: National Cheng Kung University, Tainan City (TW); CHOICE Biotech Inc., Tainan City (TW)

(72) Inventors: Jing-Jing FANG, Tainan City (TW); Tai-Hong KUO, Tainan City (TW)

(73) Assignees: National Cheng Kung University, Tainan City (TW); CHOICE Biotech Inc., Tainan City (TW)

(21) Appl. No.: 14/257,582

(22) Filed: Apr. 21, 2014

(30) Foreign Application Priority Data
Apr. 24, 2013 (TW) 102207460

(51) Int. Cl. A61C 1/08

(52) U.S. Cl. CPC A61C 1/084
USPC 433/75

(57) ABSTRACT

A guiding template for dental implantology is disclosed. The guiding template includes a fixing base and at least one metallic ring. The fixing base has an inner side and an outer side, and the fixing base includes a guiding portion as an entry at the outer side. The guiding portion has a stopper. The metallic ring is disposed on the guiding portion. Besides, the metallic ring contacts against the stopper and penetrates through the fixing base to connect the outer side to the inner side.

### CROSS REFERENCE TO RELATED APPLICATIONS

This Non-provisional application claims priority under 35 U.S.C. §119(a) on Patent Application No(s). 102207460 filed in Taiwan, Republic of China on Apr. 24, 2013, the entire contents of which are hereby incorporated by reference.

### BACKGROUND OF THE INVENTION

1. Field of Invention

The present invention relates to a guiding template for dental implantology.

2. Related Art

The dental implantology is implanting a dental implant (such as a titanic artificial tooth root) onto the alveolar bone of the mouth for replacing the original tooth root, and the implant and bone will be combined together after several months. Then, an artificial tooth can be installed onto the implant, and thereby the user can get a beautiful oral appearance and mastication function back.

Comparing with other types of surgeries, the dental implantology has a relatively lower risk. However, in order to protect the nearby tissues, such as nerves, blood vessels, and the adjacent tooth roots, and to confirm the oral appearance and mastication function after the surgery, a proper surgery planning is required. Moreover, during the operation, the auxiliary drilling instruments can help the surgeons to precisely perform the dental implantology following the set surgery planning, thereby achieving the desired medical treatment and ensuring the safety of the dental implantology and stability of the implanted artificial tooth. Clinically, regarding various body conditions and bone densities of different human bodies, the guiding template is a commonly used auxiliary instrument in dental implantology, especially for the patients of bad implantology conditions or complicated situations.

The guiding template for dental implantology is manufactured based on the preset surgery planning. In general, the surgery planning is carried out according to the structural shape of jaw, bone density and the geometric relationship between the implant and the related tissues, thereby determining the position and direction of the implant such as the boring point, angle and depth thereof. Afterwards, the guiding template is precisely fabricated according to the surgery planning so that the dental implantology can be performed exactly following the planning result. FIG. 1 is a schematic diagram showing a conventional guiding template for dental implantology. The guiding template 1 is formed according to the oral cavity as well as the relative positions of the teeth and jaw of the patient. As shown in FIG. 1, the guiding template 1 includes a plurality of guiding portions 11 and metallic rings 12. The guiding portions 11 are protruded hollow structures, and the metallic rings 12 are mounted on the hollow structures of the guiding portions 11. Herein, the metallic rings 12 are configured on the guiding template 1 based on the position, angle and depth of the implant for guiding the implantation tools and the implant following the planned path.

However, since only one surface of the metallic ring 12 is attached to the guiding portion 11, the attachment and fixing effect thereof is really limited and insufficient. In particular, when operating the implantation tools (e.g. dental drill) during the implantation surgery, the guiding template 1 is usually vibrated, which makes the metallic rings 12 loose and shift. This is not desired during the operation because the operator may not precisely perform the drilling operation.

Therefore, it is an important subject to provide a guiding template for dental implantology that has stable metallic ring for preventing the loose and shift problem caused by the vibration as the surgery instrument operates during the implantation surgery, thereby decreasing the risk of the dental implantology.

### SUMMARY OF THE INVENTION

In view of the foregoing subject, an objective of the present invention is to provide a guiding template for dental drilling and implantology that has stable metallic ring for preventing the looseness and shift problem caused by the vibration as the surgery instrument operates during the implantation surgery, thereby decreasing the risk of the dental implantology.

To achieve the above objective, the present invention discloses a guiding template for dental implantology, which includes a fixing base and at least one metallic ring. The fixing base has an inner side and an outer side. The fixing base includes a guiding portion at the outer side, and the guiding portion has a stopper. The metallic ring is disposed on the guiding portion. The metallic ring contacts against the stopper and penetrates through the fixing base to connect the outer side to the inner side.

In one embodiment of the invention, the outer side is defined with an occlusal surface, and a height difference is configured between the occlusal surface and the guiding portion.

In one embodiment of the invention, the height difference comprises an indentation portion of the guiding portion with respect to the occlusal surface.

In one embodiment of the invention, the occlusal surface is connected to a contact surface of the guiding portion, which is approximately perpendicular to the occlusal surface.

In one embodiment of the invention, the contact surface comprises an arc, wave or sawtooth structure.

In one embodiment of the invention, the inner side of the fixing base is configured with a receiving portion for mounting on a tooth, gum or jawbone.

In one embodiment of the invention, the fixing base has a shape of dental arch.

In one embodiment of the invention, the guiding template further comprises a stand portion connected with the fixing base, and the shape of the stand portion comprises a sector shape or a tongue shape.

In one embodiment of the invention, the guiding template further comprises a stand portion connected with the fixing base, and the shape of the stand portion comprises a U shape or a horseshoe shape.

In one embodiment of the invention, the guiding portion has a support stage for disposing the metallic ring.

In one embodiment of the invention, the fixing base has at least one fixing portion disposed at a cheek side of the fixing base.

In one embodiment of the invention, the fixing portion has a hollow short-pillar structure.

As mentioned above, the guiding template for dental implantology of the invention mainly includes a fixing base and a metallic ring. After mounting the metallic ring on the fixing base, the guiding template can allow various kinds of driller or implant to penetrate through. Besides, the fixing base is configured with a stopper, so that the metallic ring has sufficient support on the forced direction. As a result, the undesired shift of the metallic ring caused by the vibration of the surgery instrument or other external forces can be prevented, thereby decreasing the risk during the surgery.

In addition, the fixing base of the invention is suitable for configuring a concave guiding portion at the outer side thereof. The guiding portion and the occlusal surface have a height difference, and the metallic ring is disposed on the concave guiding portion. Accordingly, when the guiding template is mounted on the tooth, gum or jawbone of the patient, the guiding portion is not protruded from the crowns of the adjacent teeth. In other words, the fixing base only occupies a smaller space inside the mouth, so that the patient does not need to widely open his or her mouth during the surgery. This feature can substantially increase the convenience of the patient during the surgery and provide larger operation space for the surgeon, which is benefit for the following surgery operation.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a conventional guiding template for dental implantology;

FIG. 2A is a schematic diagram showing a guiding template for dental implantology according to a preferred embodiment of the invention;

FIG. 2B is an exploded view of the guiding template for dental implantology;

FIG. 3 is a sectional view of the guiding template for dental implantology of FIG. 2A along the line A-A;

FIG. 4 is a schematic diagram showing the guiding template for dental implantology and the occlusal surface of FIG. 2A;

FIG. 5 is a schematic diagram showing a part of the guiding template of FIG. 2A, which is applied to the dental implantology;

FIG. 6A is a schematic diagram showing another guiding template for dental implantology according to the embodiment of the invention; and

FIG. 6B is a schematic diagram showing another stand portion.

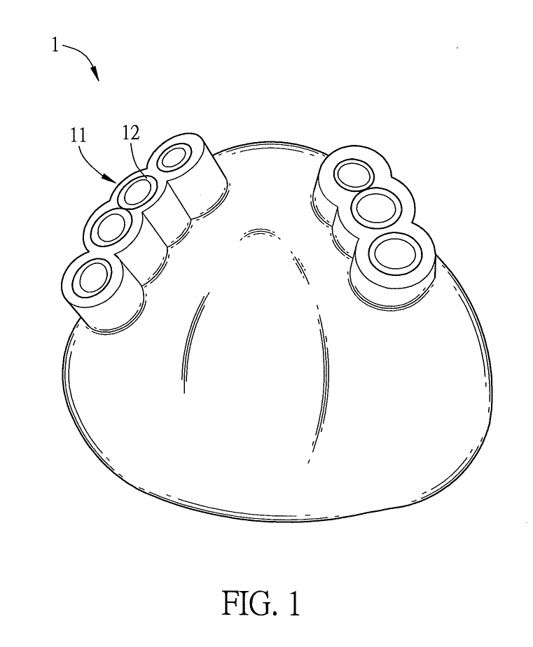

### DETAILED DESCRIPTION OF THE INVENTION

The present invention will be apparent from the following detailed description, which proceeds with reference to the accompanying drawings, wherein the same references relate to the same elements.

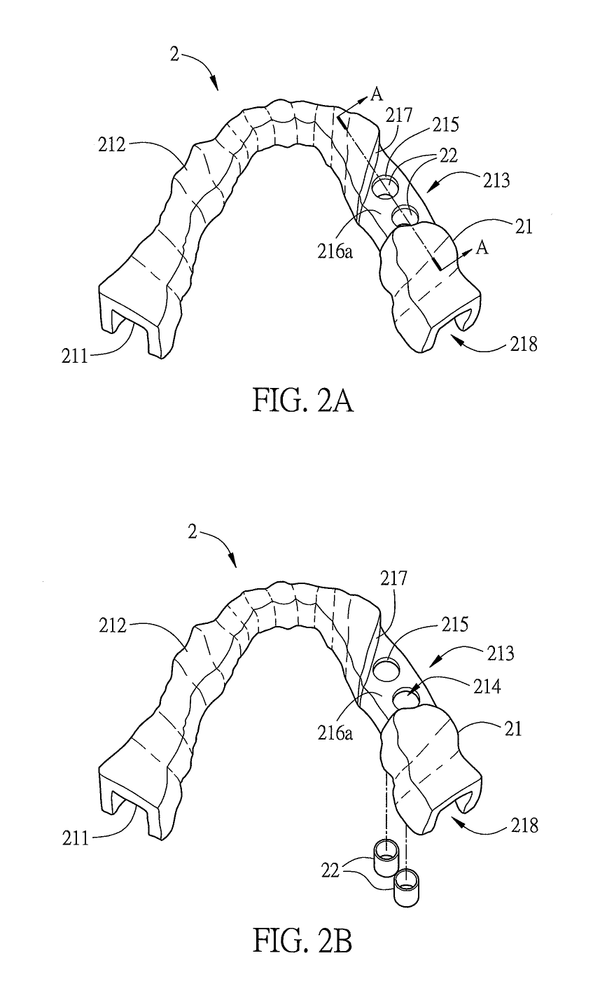

FIG. 2A is a schematic diagram showing a guiding template for dental implantology according to a preferred embodiment of the invention, and FIG. 2B is an exploded view of the guiding template for dental implantology. Referring to FIGS. 2A and 2B, the guiding template 2 for dental implantology includes a fixing base 21 and at least one metallic ring 22. The fixing base 21 has an inner side 211 and an outer side 212. The inner side 211 is mounted on the upper or lower teeth, gum or jawbone, while the outer side 212 is exploded to the mouth of the patient, or facing the opposite teeth, gum or jawbone.

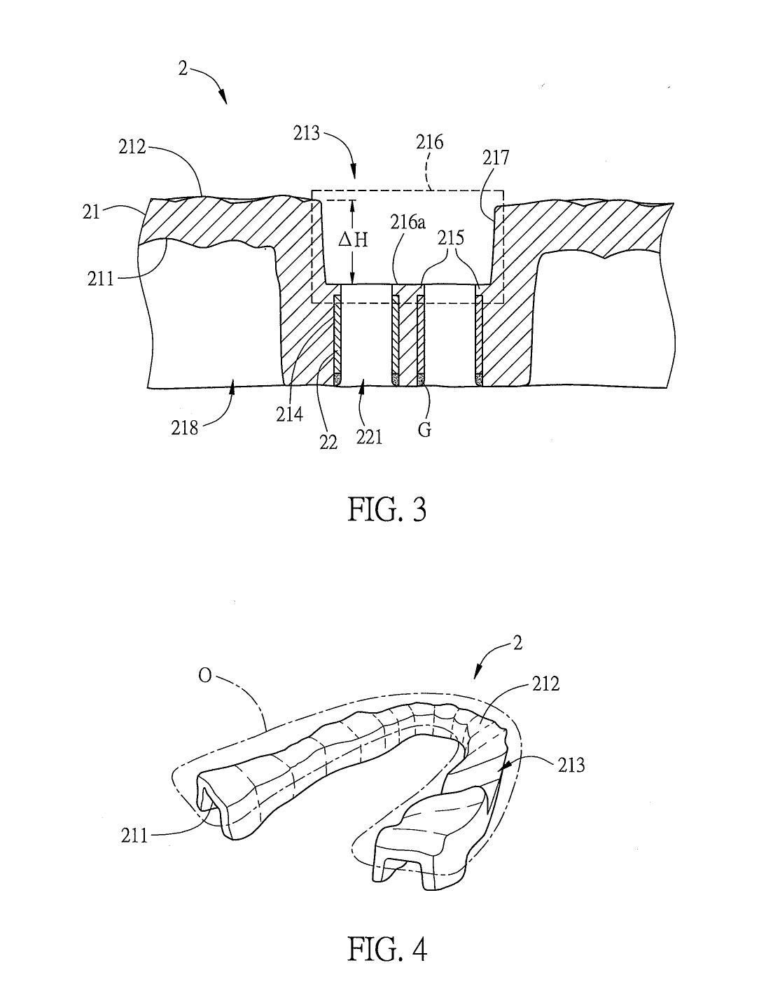

FIG. 3 is a sectional view of the guiding template for dental implantology of FIG. 2A along the line A-A. Referring to FIGS. 2B and 3, the outer side 212 of the fixing base 21 is configured with a guiding portion 213, and a hollow portion 214 is configured on the guiding portion 213 for disposing the metallic ring 22. Besides, the guiding portion 213 has a stopper 215. Herein, the fixing base 21 can be integrally formed as one piece by, for example but not limited to, rapid prototyping technology, molding, cutting, drilling or handcrafting. The structures of the guiding portion 213, the hollow portion 214 and the likes are inherently formed or defined during the design and formation procedures.

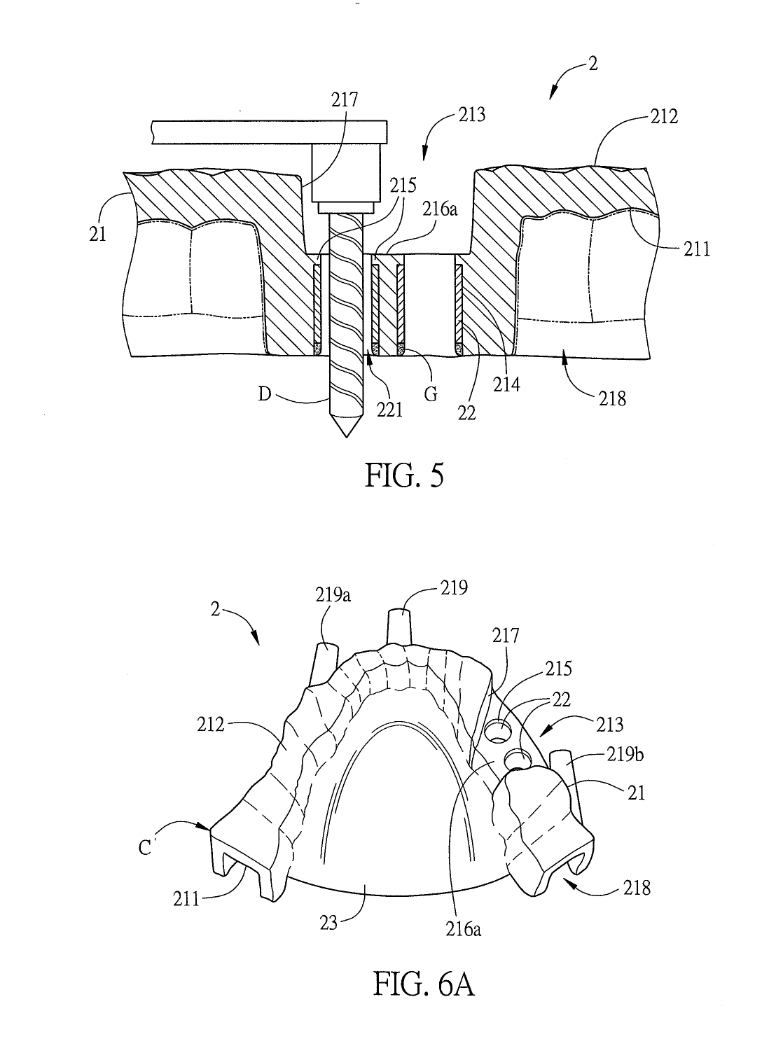

With reference to FIGS. 2B and 3, the guiding portion 213 of the fixing base 21 has a support stage 216, which is further divided into a support surface 216a and two contact surfaces 217. The metallic ring 22 is disposed in the support stage 216. In particular, the metallic ring 22 is positioned at the inner edge of the support surface 216a toward the jaw. In this embodiment, the guiding template 2 is applied to the mandible (the lower jaw). The stopper 215 is extended from the support surface 216a of the support stage 216 to the hollow portion 214, thereby preferably forming the ring structure as shown in FIG. 2B. The metallic ring 22 is mounted on the hollow portion 214 and pushes against the stopper 215, so that it can penetrate through the inner side 211 and the outer side 212 of the fixing base 21. Since the metallic ring 22 has a hollow ring-shaped short-pillar structure, an internal space 221 is formed therein (see FIG. 3). The internal space 221 inside the metallic ring 22 allows the surgery instruments (e.g. drillers D as shown in FIG. 5) or the implant to pass through.

Preferably, a glue G is coated on the other side of the metallic ring 22, which is close to the inner side 211. After the glue G is solidified or dried, the lower edge of the metallic ring 22 naturally forms a structure similar to the stopper 215. Accordingly, the two ends of the metallic ring 22 are contacted against the stopper 215 and the glue G, respectively. At first, the fixing base 21 as well as the guiding portion 213, the hollow portion 214 and the stopper 215 thereof is formed by molding. Next, the metallic ring 22 is disposed into the hollow portion 214 from the opposite side of the stopper 215, and is then tightly contacted against the stopper 215. Afterwards, the other end of the metallic ring 22, which is not contacted with the stopper 215, is coated with the glue G. This procedure is finished after the glue is solidified.

Of course, in other embodiments, the positions of the stopper and the glue can be exchanged. For example, the stopper can be configured at the inner side of the fixing base, and the metallic ring is contacted against the stopper by one end and coated with glue by the other end close to the support stage. Otherwise, it is also possible to configure two stoppers at both ends of the metallic ring, and this invention is not limited.

FIG. 4 is a schematic diagram showing the guiding template for dental implantology and the occlusal surface of FIG. 2A. Referring to FIGS. 3 and 4, the outer side 212 of the guiding template 2 is defined with an occlusal surface O, which shows the geometric shape at the position where the upper and lower teeth are closed. In other words, when the guiding template 2 is installed on the upper or lower jaw, the occlusal surface O almost covers the surface of the crowns of the upper or lower jaw. As shown in FIG. 3, a height difference ΔH is configured between the occlusal surface O and the guiding portion 213. In practice, the height difference ΔH is determined according to the structure of the teeth or jawbone around the location of the implant.

In this embodiment, the guiding portion 213 has an indentation portion toward the inner side 211 with respect to the occlusal surface O. In other words, the guiding portion 213 takes the occlusal surface O as a reference surface and has an indentation structure with a height difference ΔH toward the inner side 211 from the reference surface. Since the metallic ring 22 is disposed at the indentation portion of the guiding portion 213 with respect to the occlusal surface O and has a height difference ΔH, the guiding portion 213 will not protrude from the crowns of adjacent teeth as the guiding template 2 is mounted on the tooth, gum or jawbone of the patient. That is, the guiding template 2 only occupies a smaller space inside the mouth, so that the patient does not need to widely open his or her mouth during the surgery. This feature can substantially increase the convenience of the patient during the surgery and provide larger operation space for the surgeon, which is benefit for the following surgery operation.

With reference to FIGS. 2A to 3, the support surface 216a of the support stage 216 makes the guiding portion 213 to form a substantially planar structure for cooperating with the shape of the surgery instruments. This configuration can maintain the stability of the surgery instruments and the guiding template 2. In addition, the guiding portion 213 of this embodiment is directly connected with the occlusal surface O through the contact surface 217 (see FIG. 4). Herein, the contact surface 217 may have different shapes or tilt angles according to the shape of the surgery instrument. For example, the contact surface 217 of this embodiment is a planar vertical surface. However, in other embodiments, the contact surface may have a single arc, wave or sawtooth structure, and be approximately or substantially perpendicular to the support surface. By the various combinations of the above aspects, the surgery instruments can be perfectly cooperated so as to facilitate the operation of surgeons and further prevent the problems of rotating the instruments or placing the instruments into the guiding portion.

FIG. 5 is a schematic diagram showing a part of the guiding template 2 of FIG. 2A, which is applied to the dental implantology (for lower jaw). Referring to FIG. 5, in practice, the positions of the guiding portion 213 and the metallic ring 22 as well as the angle and depth of the metallic ring 22 are determined according to preset surgery planning, which is made depending on the structure and shape of the teeth and the geometric relationship between the important tissues. After the implant is properly disposed, the type of the fixing base 21 and the positions of the guiding portion 213 and the metallic ring 22 are determined according to the surgery planning. Then, the surgery can be carried out based on the planning result. As shown in FIG. 5, the driller D can pass through the internal space 221 and be limited by the metallic ring 22, thereby being guided along the planned path so as to drill a proper space on the jawbone for disposing the implant. Similarly, the implant can also be guide to this space by the metallic ring 22. In general, the driller D will cause the vibration of the guiding template 2 during the surgery, which may lead to the looseness of the metallic ring 22. In this invention, the guiding template 2 is configured with the stopper 215 and the glue G, so that the metallic ring 22 has proper support on the forced direction. This configuration can prevent the undesired looseness or shift of the metallic ring 22 caused by the vibration of driller D or other surgery instruments, thereby decreasing the risk during the surgery. The stopper 215 is disposed close to the support surface 216a for providing a planar surface to cooperate with the driller D. In other embodiments, it is possible to configure only stopper (without the coated glue). When applying to the lower jaw, the stopper is disposed close to the inner side for providing the desired support to the metallic ring on the forced direction.

In addition, the guiding template 2 may have different types such as the tooth support, gum support and jawbone support according to the position and situation of the patient. Referring to FIGS. 2A and 2B, the inner side 211 of the fixing base 21 may further include a receiving portion 218 for mounting on the tooth, gum or jawbone of the patient. To be noted, the figures only show the aspect of mounting on the tooth, but this invention is not limited thereto. The shape of the receiving portion 218 is designed corresponding to the tooth crown shape or jawbone shape of the patient, thereby increasing the stability of the guiding template 2. Besides, the fixing base 21 has a shape of dental arch, which is also formed corresponding to the teeth structure of the patient. In more detailed, the tips and grooves of the teeth are marked and connected to generate the dental arch in the surgery planning. During the formation of the guiding template 2, the fixing base 21 is formed according to the shape of dental arch.

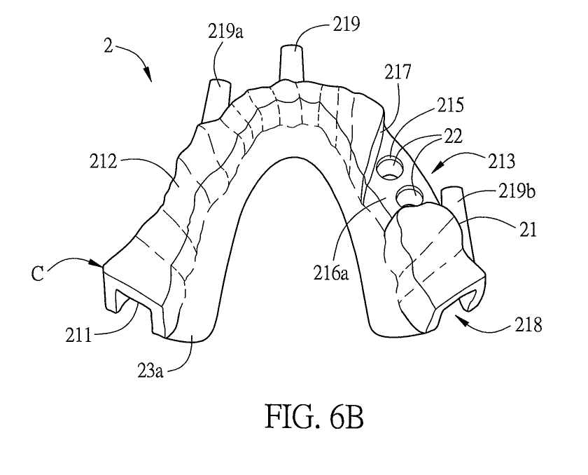

FIG. 6A is a schematic diagram showing another guiding template for dental implantology according to the embodiment of the invention. Referring to FIG. 6A, in another embodiment, the guiding template 2 further includes a stand portion 23 connected with the fixing base 21, and the shape of the stand portion 23 includes a sector shape or a tongue shape, which can entirely cover the upper or lower jaw of the patient. Accordingly, the guiding template 2 can be installed on the tooth, gum or jawbone of the patient more stable. In addition, FIG. 6B is a schematic diagram showing another stand portion 23a. Referring to FIG. 6B, the stand portion 23a is extended from the fixing base 21 and has a U shape or a horseshoe shape, which can only partially cover the upper or lower jawbone. Of course, this design can also firmly dispose the guiding template 2.

As shown in FIG. 6A, the fixing base 21 has at least one fixing portion 219 disposed at the cheek side C of the fixing base 21. The cheek side C is the side wall of the fixing base 21 close to the cheek or chin of the patient. During the full-mouth dental implantology, the operation procedures are very complicated and take a long time. Accordingly, it is needed to use a fixing pin for fixing the guiding template 2 on the teeth, gum or jawbone of the patient. The fixing portion 219 has a hollow short-pillar structure, so that the fixing pin can penetrate through the fixing portion 219 so as to fix the guiding template 2 for improving the stability of the dental implantology. Of course, the number of the fixing portion 219 is not limited. Preferably, the fixing portion 219 is disposed on the cheek side C of the fixing base 21, and the structure of the fixing portion 219 is perpendicular to the cheek side C. Moreover, additional fixing portions 219a and 219b are disposed on the cheek side C close to the cheeks of the patient, respectively. In order to avoid the blood vessels in the gum of the patient, the structure of the additional fixing portions 219a and 219b are proximately parallel to the cheek side C. This configuration can also facilitate to install the fixing pins.

In summary, the guiding template for dental implantology of the invention mainly includes a fixing base and a metallic ring. After mounting the metallic ring on the fixing base, the guiding template can allow various kinds of driller or implant to penetrate through. Besides, the fixing base is configured with a stopper, so that the metallic ring has sufficient support on the forced direction. As a result, the undesired shift of the metallic ring caused by the vibration of the surgery instrument can be prevented, thereby decreasing the risk during the surgery.

In addition, the fixing base of the invention is suitable for configuring a concave guiding portion at the outer side thereof. The guiding portion and the occlusal surface have a height difference, and the metallic ring is disposed on the concave guiding portion. Accordingly, when the guiding template is mounted on the tooth, gum or jawbone of the patient, the guiding portion is not protruded from the crowns of the adjacent teeth. In other words, the fixing base only occupies a smaller space inside the mouth, so that the patient does not need to widely open his or her mouth during the surgery. This feature can substantially increase the convenience of the patient during the surgery and provide larger operation space for the surgeon, which is benefit for the following surgery operation.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A guiding template for dental implantology, comprising:
a fixing base having an inner side and an outer side, wherein the fixing base comprises a guiding portion at the outer side and the guiding portion has a stopper; and
at least a metallic ring disposed on the guiding portion, wherein the metallic ring contacts against the stopper and penetrates through the fixing base to connect the outer side to the inner side.

2. The guiding template of claim 1, wherein the outer side is defined with an occlusal surface, and a height difference is configured between the occlusal surface and the guiding portion.

3. The guiding template of claim 2, wherein the height difference comprises an indentation portion of the guiding portion with respect to the occlusal surface.

4. The guiding template of claim 2, wherein the occlusal surface is connected to a contact surface of the guiding portion, which is approximately perpendicular to the occlusal surface.

5. The guiding template of claim 4, wherein the contact surface comprises an arc, wave or sawtooth structure.

6. The guiding template of claim 1, wherein the inner side of the fixing base is configured with a receiving portion for mounting on a tooth, gum or jawbone.

7. The guiding template of claim 1, wherein the fixing base has a shape of dental arch.

8. The guiding template of claim 1, further comprising:
a stand portion connected with the fixing base, wherein the shape of the stand portion comprises a sector shape or a tongue shape.

9. The guiding template of claim 1, further comprising:
a stand portion connected with the fixing base, wherein the shape of the stand portion comprises a U shape or a horseshoe shape.

10. The guiding template of claim 1, wherein the guiding portion has a support stage for disposing the metallic ring.

11. The guiding template of claim 1, wherein the fixing base has at least a fixing portion disposed at a cheek side of the fixing base.

12. The guiding template of claim 11, wherein the fixing portion has a hollow short-pillar structure.
